(19) United States
(12) Patent Application Publication
(10) Pub. No.: US 2018/0345049 A1
(43) Pub. Date: Dec. 6, 2018

(54) AXIAL BUFFER DEVICE AND FALL PROTECTION DEVICE HAVING THE SAME

(71) Applicant: YOKE INDUSTRIAL CORP., TAICHUNG CITY (TW)

(72) Inventors: Wei-Chieh Hung, Taichung City (TW); Eason Sun, Taichung City (TW)

(73) Assignee: YOKE INDUSTRIAL CORP., TAICHUNG CITY (TW)

(21) Appl. No.: 15/875,246

(22) Filed: Jan. 19, 2018

(30) Foreign Application Priority Data
Jun. 1, 2017 (TW) 106118118

(51) Int. Cl. A62B 1/10; A62B 35/00

(52) U.S. Cl. CPC A62B 1/10; A62B 35/0075

(57) ABSTRACT

An axial buffer device and a fall protection device including the axial buffer device are disclosed. The axial buffer device includes a buffer rod having a first friction surface; and a buffer member having a second friction surface which contacts the first friction surface. When any one of the buffer rod and the buffer member is pulled by a force which is greater than a default value to overcome a maximum friction between the buffer member and the buffer rod, the buffer member would slide on the buffer rod with friction to cushion the pulling force. The fall protection device includes a frame, a rotary member disposed in the frame and adapted to roll up a safety belt, and the axial buffer device. One of the buffer rod and the buffer member is connected to a hanging point and the other one is connected to the frame.

### BACKGROUND OF THE INVENTION

### 1. Technical Field

The present invention is related to a buffer device, and more particularly to an axial buffer device and a fall protection device.

### 2. Description of Related Art

Working in elevated environments like roofs, factories, construction sites, aerospace bases, or in the situations like elevator repairing or shipbuilding, workers are usually required to wear safety equipment like fall protection device when they are working. The fall protection device is adapted to be connected with a safety belt, and the safety belt is fastened to the worker. When the worker falls from an elevated site accidentally, the fall protection device can stop or buffer the safety belt to prevent the worker continue to fall or slow down the falling speed of the worker to secure the safety of the worker.

Conventional fall protection devices may include an elastic stretch design for the safety belt, with this design as the worker attached with the safety belt falls, this stretchable safety belt can buffer or slow down the falling speed of the worker. However, the length, the elastic modulus, the height of the work site, also the weight of the worker, all of them must be considered when designing the safety belt. In the case that the length of the safety belt is too long, once the worker falls without the rebounding of the safety belt and hits the ground, injuries may occur.

There is another fall protection device having a portion of the safety belt with an overlay-sewing design. With this design on the safety belt, when the worker attached with the safety belt falls, the overlay-sewing portion of the safety belt would be ripped by the downward force, absorb the downward impulsive force of the worker, thereby providing the cushion effect. However, this design may damage the structure of the safety belt, affect its strength, and lower the load-bearing capacity, which may result in a dangerous situation.

Besides, there is also a fall protection device with a rapid lock-up design. As the worker falls, the pulling force will make the fall protection device lock up the safety belt immediately so as to prevent the worker from continuing to drop. However, this design may cause an instant impact force (like G-Force) and a counter force which may cause organ injuries or bone fractures to the worker.

### BRIEF SUMMARY OF THE INVENTION

In view of the above, an object of the present invention is to provide an axial buffer device and a fall protection device having the axial buffer device. By utilizing the design of the axial buffer device, it is favorable to buffer a falling speed or shorten a falling distance of an object which the axial buffer device is applied to. For example, when the axial buffer device is applied to the fall protection device, it is favorable to buffer a falling speed or shorten a falling distance of a worker or an object which is attached to the fall protection device. In addition, the axial buffer device could be applied to other objects, such as a pull ring, a hoist ring, a hook, a cord, etc. to provide a good buffer mechanism.

The present invention provides an axial buffer device, including a buffer rod having a first friction surface; and a buffer member having a second friction surface which contacts the first friction surface; when any one of the buffer rod and the buffer member is pulled by a force which is greater than a default value to overcome a maximum friction between the buffer member and the buffer rod, the buffer member would slide on the buffer rod with friction.

In one embodiment, the axial buffer device further includes a first spring, wherein the first spring is connected to the buffer rod to provide an elastic force to the buffer rod.

In one embodiment, the first spring is fit around the buffer rod; one of two ends of the first spring is connected to the buffer rod, and another one of the two ends of the first spring is connected to the buffer member.

In one embodiment, the axial buffer device further includes a second spring, wherein the second spring is fit around the buffer rod and interposed between the first spring and the buffer rod; one of two ends of the second spring is adapted to connect to the buffer rod, and another one of the two ends of the second spring is adapted to connect to the buffer member.

In one embodiment, an outer peripheral surface of the buffer rod forms the first friction surface; a through hole is disposed on the buffer member and includes an inner peripheral surface which forms the second friction surface; a fitting relation between the second friction surface and the first friction surface is an interference fit.

In one embodiment, the buffer member comprises a holder and a first buffer ring; the first buffer ring and the buffer rod are disposed within the holder; the first buffer ring is fit around the buffer rod and includes the second friction surface.

In one embodiment, the axial buffer device further includes a first spring, wherein the first spring is fit around the buffer rod; one of two ends of the first spring is connected to the buffer rod, and another one of the two ends is connected to the first buffer ring.

In one embodiment, the axial buffer device further includes a second spring, wherein the second spring is fit around the buffer rod and interposed between the first spring and the buffer rod; one of two ends of the second spring is connected to the buffer rod, and another one of the two ends of the second spring is connected to the first buffer ring.

In one embodiment, the buffer member further includes a second buffer ring; the second buffer ring is fit around the buffer rod and includes a third friction surface which faces the first friction surface of the buffer rod; the axial buffer device further comprises a first spring and a second spring; the first spring is fit around the buffer rod and disposed between the first buffer ring and the second buffer ring; two ends of the first spring respectively connect to the first buffer ring and the second buffer ring; the second spring is fit around the buffer rod; two ends of the second spring respectively connect to the second buffer ring and the buffer rod.

In one embodiment, the axial buffer device further includes another buffer rod, wherein the two buffer rods are disposed coaxially; the buffer member includes a holder, a first buffer ring, and a second buffer ring; the two buffer rods, the first buffer ring and the second buffer ring are disposed within the holder; the first buffer is fit around the buffer rod and includes the second friction surface; the second buffer ring is fit around the other buffer rod and includes a third friction surface which contacts a fourth friction surface on the other buffer rod.

In one embodiment, the axial buffer device further includes at least one spring, wherein the at least one spring is fit around one of the two buffer rods.

The present invention also provides a fall protection device adapted to connect to a safety belt. The fall protection device includes a frame, a rotation member disposed in the frame and adapted to roll up the safety belt, and the aforementioned axial buffer device, wherein one of the buffer rod and the buffer member is adapted to connect to a hanging point, and the other one is adapted to connect to the frame.

In one embodiment, the fall protection device further includes a brake unit and a housing, wherein the brake unit is disposed on the rotation member to restrict a rotation of the rotation member; the housing includes a first half housing and a second half housing which are opposite and joined to each other; a first division plate is disposed in the first half housing and a second division plate is disposed in the second half housing which is opposite to the first division plate; the rotation member is disposed in one part of the housing which is at one side of the first division plate and the second division plate, and the brake unit is disposed in another part of the housing which is at another side of the first division plate and the second division plate.

In one embodiment, the rotation member includes a shaft lever and a rotary drum; the brake unit is mounted on the shaft lever; the rotary drum is fit around the shaft lever to be rotated with the shaft lever coaxially.

In one embodiment, a fitting relation between the rotary drum and the shaft lever is an interference fit.

The advantage of the present invention is that: by utilizing the friction surfaces of the buffer rod and the buffer member of the axial buffer device which face to each other, the sliding friction generated between the buffer rod and the buffer member could cushion a force (or an impulsive force) when the force applied to the buffer rod or the buffer member is greater than a default value, whereby to buffer and absorb a falling force of the worker, and slow down a falling speed of the worker, which could avoid an injury to the worker. In addition, the probability of rebounding which makes a secondary damage to the worker also could be decreased.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of an axial buffer device of a first embodiment according to the present invention;

FIG. 2 is an exploded view of the axial buffer device of the first embodiment;

FIG. 3 is a perspective view of a fall protection device of an embodiment according to the present invention;

FIG. 4 is an exploded view of the fall protection device of FIG. 3;

FIG. 5 and FIG. 6 are cross-sectional views of the fall protection device of FIG. 4 as viewed along line A-A of FIG. 4 which show relative positions of the buffer rod and the buffer member before and after the relative movement;

FIG. 7 is a schematic view showing a falling test of the fall protection device;

FIG. 8 is a cross-sectional view of a fall protection device of another embodiment according to the present invention;

FIG. 9 is a cross-sectional view of an axial buffer device of a second embodiment according to the present invention;

FIG. 10 is a schematic view of an axial buffer device of a third embodiment according to the present invention;

FIG. 11 is a schematic view of an axial buffer device of a fourth embodiment according to the present invention;

FIG. 12 is a schematic view showing the axial buffer device of an embodiment is applied to a hook according to the present invention; and

FIG. 13 is a schematic view showing the axial buffer device of an embodiment is connected to a cord according to the present invention.

### DETAILED DESCRIPTION OF THE INVENTION

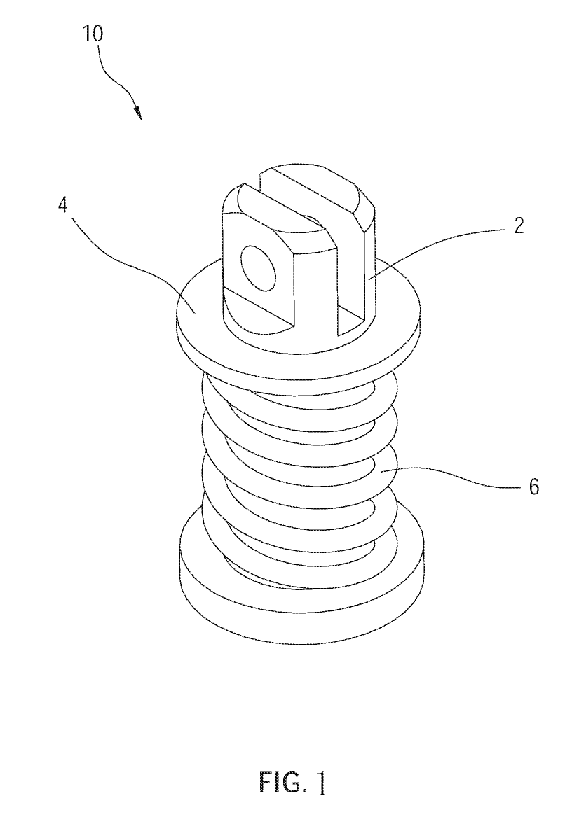

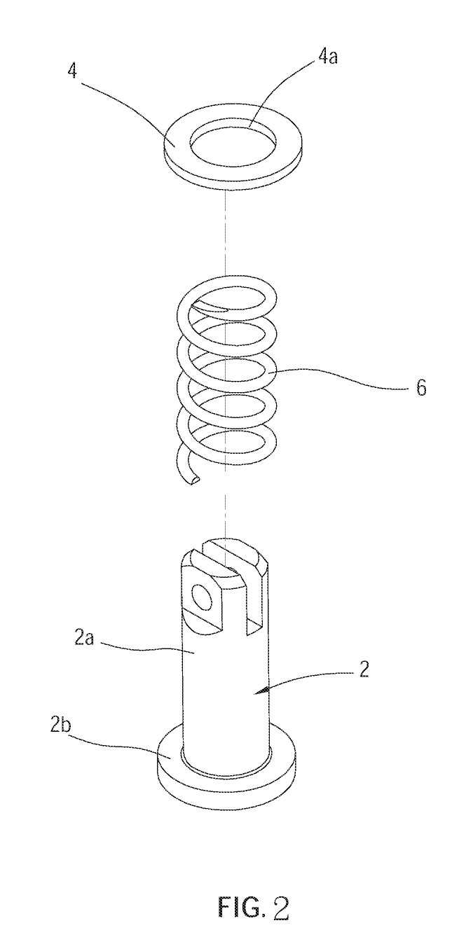

The following illustrative embodiments and drawings are provided to illustrate the disclosure of the present invention, these and other advantages and effects can be clearly understood by persons skilled in the art after reading the disclosure of this specification. As illustrated in FIG. 1 and FIG. 2, an axial buffer device 10 of a first embodiment according to the present invention includes a buffer rod 2 and a buffer member.

The buffer rod 2 includes a first friction surface 2a. In the current embodiment, an outer peripheral surface of the buffer rod 2 forms the first friction surface 2a. In addition, the buffer rod 2 further includes a flange 2b, wherein the flange 2b is disposed at one end of the buffer rod 2 and protruded from the outer peripheral surface of the buffer rod 2.

The buffer member includes a second friction surface facing to the first friction surface 2a. In the current embodiment, the buffer member includes a first buffer ring 4. The buffer ring 4 includes a through hole, and an inner peripheral surface of the through hole forms the second friction surface 4a, wherein the first buffer ring 4 is adapted to be fit around the buffer rod 2 and contacts with the first friction surface 2a. Preferably, the fitting relation between the first buffer ring 4 and the buffer rod 2 is an interference fit (or a tight fit). In addition, in other applications, the fitting relation also could be a transition fit or a clearance fit, etc. Whereby, when a force applied to the buffer rod 2 or the first buffer ring 4, such as a component of an external force which is parallel to the axial direction of the buffer rod 2, is greater than a default value, the first buffer ring 4 would slide with friction on the buffer rod 2 by the force against to the maximum friction force between the first buffer ring 4 and the buffer rod 2 so as to buffer, absorb or offset the force.

Moreover, the axial buffer device 10 can further include a first spring 6. The first spring 6 is adapted to be connected to the buffer rod 2 to provide an elastic force for increasing the buffering effect of the buffer rod 2. In the current embodiment, the first spring 4 is fit around the buffer rod 2, wherein one of the two ends of the first spring 4 is adapted to be connected to the flange 2b of the buffer rod 2, and another of the two ends of the first spring 4 is adapted to be connected to first buffer ring 4. In more details, in the current embodiment, the first spring 4 is a compressed spring as an example, wherein two ends of the compressed spring abut against the flange 2b of the buffer rod 2 and the surface of the first buffer ring 4 respectively. Whereby, when the first buffer ring 4 slides with friction on the buffer rod 2 to be close to the flange 2b, the first spring 6 would be compressed to form an elastic force which could be used to buffer the force.

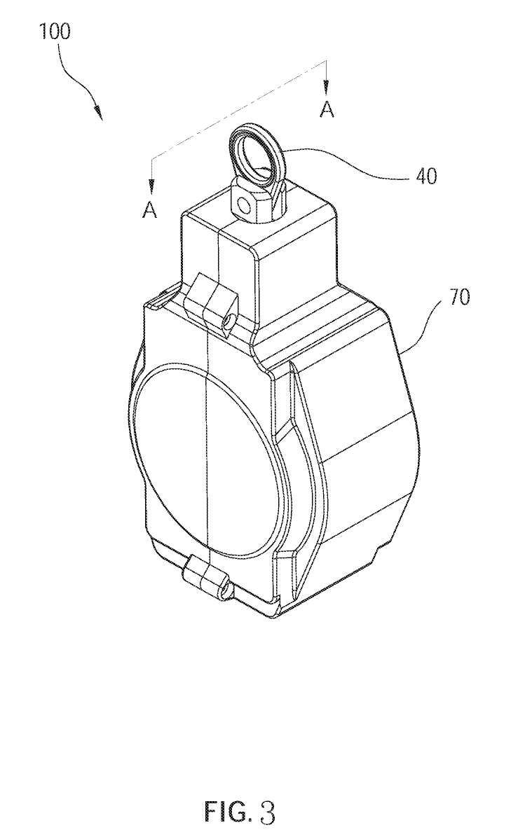

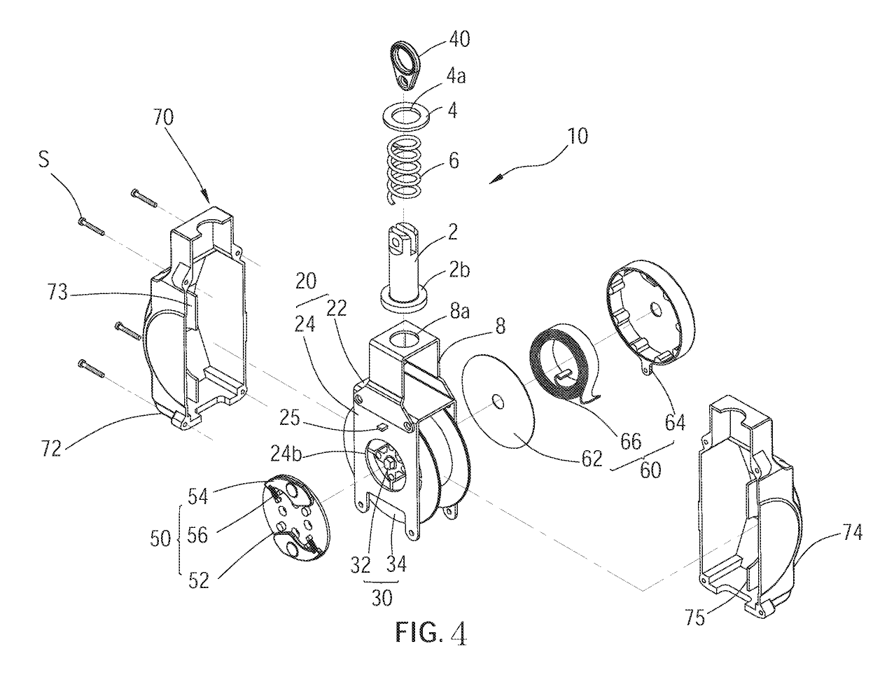

Referring to FIG. 3 and FIG. 4, a fall protection device 100 of an embodiment according to the present invention is illustrated. The fall protection device 100 includes a frame 20, a rotation member 30 and an axial buffer device. The frame 20 includes a top plate 22 and two lateral plates 22. The top plate 22 is connected between the two lateral plates 14, and the top plate 12 and the two lateral plates 14 constitute a containing space for containing the rotation member 30. One of the lateral plates 24 includes a through hole 24a, and the other lateral plate 24 includes a through hole 24b, wherein the through hole 24a and the through hole 24b are disposed coaxially.

The rotation member 30 includes a shaft lever 32 and a rotary drum 34. The shaft lever 32 penetrates through the through hole 24a, and the rotary drum 34 is mounted on the shaft lever 32 to be rotated with the shaft lever 32 coaxially. The rotary drum is adapted to roll up a safety belt 36, wherein one end of the safety belt 36 is adapted to be connected to a worker or a hanging point of a safety equipment wearing by the worker. In one embodiment, a fitting relation between the rotary drum 34 and the shaft lever 32 includes an interference fit (or a tight fit), such as a transition fit or a clearance fit, whereby a rotational friction would be generated between the rotary drum 34 and the shaft lever 32 due to the tight fit design of the rotary drum 34 and the shaft lever 32 when the shaft lever 32 stops rotating, which enables a slowing down of the falling speed of the safety belt 36 while being stretched out and deceleration of the falling speed of the worker worn with the safety belt 32. However, in other applications, the fitting relation of the shaft lever 32 and the rotary drum 34 is not limited to the above embodiment.

In the current embodiment, the axial buffer device includes a structure of the axial buffer device of the aforementioned embodiment. Therefore, the detailed description thereof is omitted here. The buffer member of the axial buffer device 10 further includes a holder 8. The holder 8 is disposed on the frame 20. In the current embodiment, a plurality of positioning holes are provided at a bottom of the holder 8, wherein the plurality of positioning holes could be penetrated with a plurality of bolts to fasten the holder 8 on the frame 20. However, in other applications, other fastening methods also could be utilized.

One of the buffer rod 2 and the buffer member is adapted to be connected to a hanging point, and the other is connected to the frame 20. In the current embodiment, the buffer rod 2 is disposed on the frame 20, and one end of the buffer rod 2 penetrates through a through hole 8a of the holder 8 to be connected to a hanging point. A hanging ring 40 is connected to one end of the buffer rod 2, and is adapted to hang on or fix to a hanging point. Alternatively, the hanging ring 40 also could be utilized together with a cord to connect to the hanging point. Wherein, the hanging point includes, for example, a steel reinforcing bar, a pillar, a steel cord or a cable rope which enables the buffer rod 34 to indirectly or directly connect to the hanging point, but it is not limited thereto. In addition, the hanging point is not limited to a fixed point or an anchoring point. For example, the hanging point could be a hanging member which is connected to a cord which could slide along a longitudinal direction of the cord. In another embodiment, the buffer rod 2 could be connected to the frame directly or indirectly and the holder 8 could be connected to the hanging point directly or indirectly. It is not limited thereto.

Furthermore, in the current embodiment, the fall protection device 100 further includes a brake unit 50, a rewinding unit 60 and a housing 70.

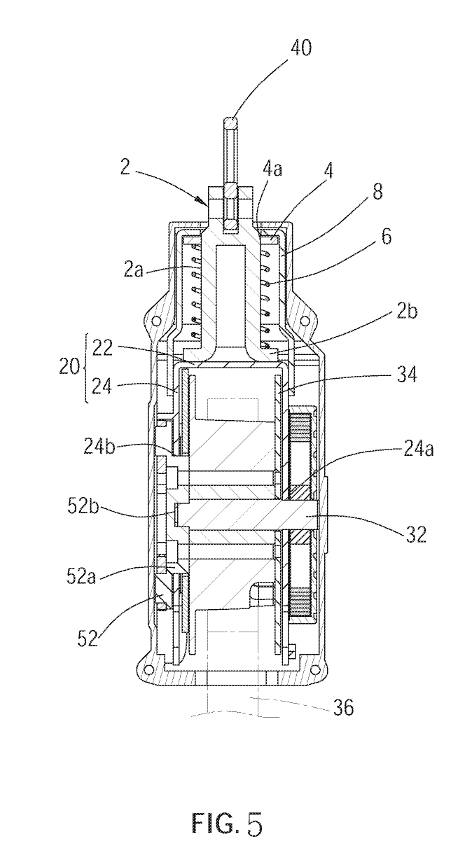

The brake unit 50 is disposed on the rotation member 30. As shown in FIG. 4 and FIG. 5, the brake unit 50 of the current embodiment includes a braking plate 52, two braking parts 54, and two restoring springs 56. The braking plate 52 includes a protrusion part 52a. The protrusion part 52a is fit into the through hole 24b of the lateral plate 14. A recess 52b is formed on the protrusion part 52a and is adapted to be engaged with the shaft lever 32, and the braking plate 52 could be rotated with the shaft 22 coaxially. The two braking parts 54 are pivotally connected to the braking plate 52 respectively. One end of each of the two restoring springs 56 is connected to one of the braking parts 54, and another end is connected to the braking plate 52, which provides an elastic force to each of the two braking parts 54 to keep each of the braking parts 54 in a retracted position.

The rewinding unit 60 includes a first cover 62, a second cover 64 and a spiral spring 66. Wherein, the first cover 62 is combined with the second cover 64 to form a containing space for receiving the spiral spring 66 which coils up normally One end of the spiral spring 66 is connected to the shaft lever 32, and another is connected to the second cover 64.

The housing 70 is adapted to receive the axial buffer device 10, the frame 20, the rotation member 30, the brake unit and the rewinding unit 60. The housing 70 includes a first half housing 72 and a second half housing 74 which are joined to each other, wherein a first division plate 73 is provided in the first half housing 72, and a second division plate 75 is provided in the second half housing 74; the first division plate 73 and the second division plate 75 are opposite to each other. The first half housing 72 and the second half housing 74 could be combined together by positioning members such as bolts S, whereby the first division plate 73 and the second division plate 75 could be joined to each other to divide the containing space of the housing 70 into two parts. One part of the containing space which is located at one side of the first division plate 73 and the second division plate 75 is adapted to receive the frame 20 and the rotation member 30, and another part of the containing space which is located at the other side of the first division plate 73 and the second division plate 75 is adapted to receive the brake unit 50. With the design of the first division plate 73 and the second division plate 75, the rotation member 30 could be isolated from the brake unit 50 and thereby to prevent small objects such as dust particles carried by the safety belt 36 which is wound around the rotation member 30 being entered or adhered to the brake unit 50 and decrease the interference to the operation of the brake unit 50. Besides, the spiral spring 66 is received in the first cover 62 and the second cover 64, which is capable of avoiding the intrusion of the small objects such as dust particles as well. Moreover, the axial buffer device 10 is isolated with the top plate 22, which is also favorable to avoid the intrusion or adhesion of small objects such as dust particles carried by the rotation member 30 and the safety belt 36. In addition, in one embodiment, the axial buffer device 10 is not limited to be enclosed by the housing 70, and could be exposed on an exterior of the housing 70.

With the above-mentioned design, in a normal situation, for example, as a worker walks normally on a working platform or a pallet, the rotation unit 30, the brake unit 50, and the rewinding unit 60 rotates coaxially (or synchronous rotary). When the safety belt 36 bears a pulling force smaller than a default value, for example, the worker attached with the safety belt 36 is away from the fall protection device 100 and the safety belt 36 is being pulled, the spiral spring 66 of the rewinding unit 60 stretches and stores a restoring force (or elastic force) for coiling because of the pulling from the safety belt 36. On the contrary, when the worker approaches the fall protection device 100, the force to pull the safety belt 36 would decrease to a value lower than the elastic force of spiral spring 66 such that the elastic recovery appears and the spiral spring 66 coils back so as to drive the safety belt 36 to wind around the rotary drum 34 again.

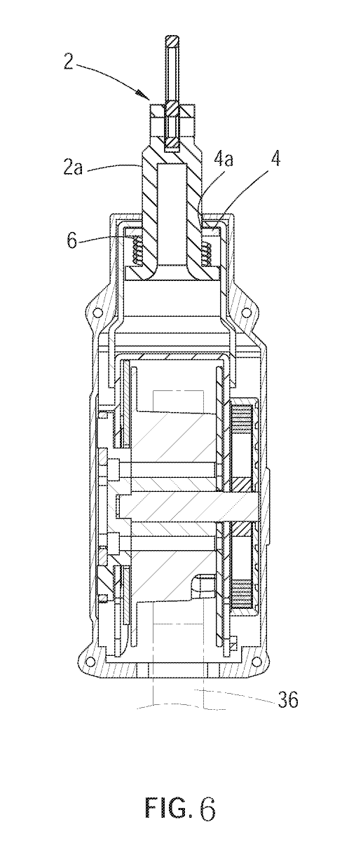

In another situation that the safety belt 26 is being pulled rapidly at a moment, such as a worker attached with the safety belt 26 falls from an elevated site accidentally, the safety belt 26 would be pulled out rapidly by a pulling force which is greater than the default value, whereby the braking parts 54 of the brake unit 50 would be spun out by overcoming the elastic force of the restoring spring 56. Then, the braking parts 54 would engage with a stopper 25 disposed on the frame 20, which fixes the braking plate 52, as well as the shaft lever 32 which is connected to the braking plate 52. Referring to FIG. 4 and FIG. 5, because of the engagement of the brake unit 50 and the secure fixation of the shaft 22, the pulling force applied to safety belt 26 would also pull the frame 20 together with the holder 32, which is connected to the frame 20, to move downwardly. Meanwhile, the holder 8 would bring the first buffer ring 4 to move downward, which overcomes the maximum friction between the second friction surface 4a of the first buffer ring 4 and the first friction surface 2a of the buffer rod 2 disposed at the hanging point, and makes the first buffer ring 4 to slide on the buffer rod 2 with friction to generate a relative movement as shown in FIG. 6. Wherein, the sliding friction generated between the first friction surface 2a of the buffer rod 2 and the second friction surface 4a of the first buffer ring 4 could cushion the falling force (or impulsive force) of the safety belt 26 and the worker attached with the safety belt 26 so as to buffer and absorb the falling force of the worker, and slow down the falling speed of the worker, thereby avoiding injury to the worker. In addition, the occurrence of the rebounding of safety belt 26 and the secondary damage to the worker also could be reduced.

As shown in FIG. 5 and FIG. 6, it is worth mentioning that in this embodiment, the elastic force provided by abutting the first spring 6 against the buffer rod 2 and the first buffer ring 4 could be combined with the sliding friction between the buffer rod 2 and the first buffer ring 4 to improve the performance of buffering and offsetting the falling force of the safety belt 36 and the worker. For example, when the safety belt 36 is being pulled down to rotate the rotation member 30 and the frame 20, the first buffer ring 4 would be driven to slide on the buffer rod 2 to generate a relative movement which compresses the first spring 6 disposed therebetween, whereby the elastic force generated by compressing the first spring 6 in the opposite direction could be utilized to cushion the falling force of the safety belt 36. Besides, in a situation when the falling force is removed, the restoring elastic force of the first spring 6 also could be utilized to restore the buffer rod 2 and the first buffer ring 4 to the initial state as shown in FIG. 5. It is worth mentioning that it is not limited to be provided with the first spring 6. In one embodiment, the first spring 6 could be omitted, and only the sliding friction generated between the buffer rod 2 and the first buffer ring 4 is utilized to cushion the falling force of the safety belt 36.

Furthermore, the first spring 6 is not limited to the compressed spring. In one embodiment, the first spring 6 could be a tension spring to be connected between the frame 20 and the buffer rod 2, which provides an elastic force for restoring the buffer rod 2 to its initial position. In addition, in other applications, other types of springs also could be utilized. In one embodiment, two ends of the tension spring could be connected to the holder 8 and the first buffer ring 4 respectively to provide a restoring elastic force to cushion the falling force.

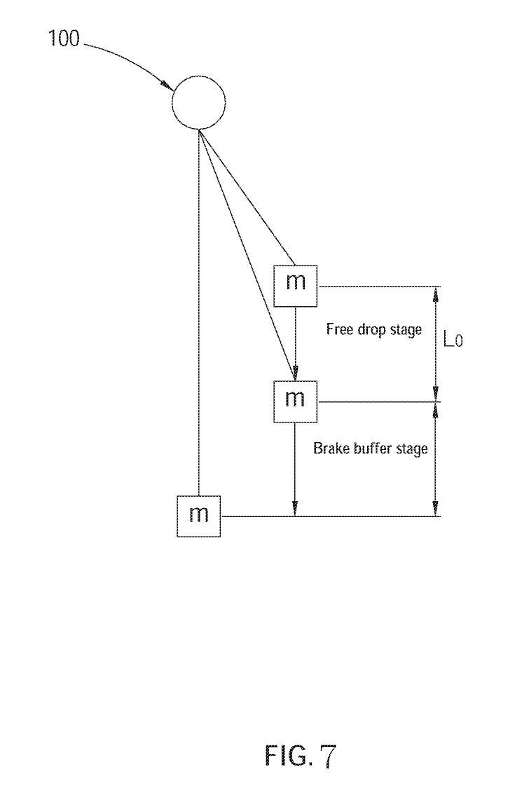

As illustrated in FIG. 7, a free drop stage of a test weight refers to a period between releasing from a static state and an initiation of a brake unit (e.g. the brake unit 50), while a brake buffer stage of the test weight refers to a period between the initiation of the brake unit and being held as static again. Wherein, a physical model equation of a fall protection device which utilizes conventional linings or woven type energy absorbers to provide the brake buffer effect is as follows: m*g* (L_0+X) =f_s*X, wherein m is mass of the test weight; g is gravitation acceleration; L0 is a distance of free drop; fs is a brake buffer force; X is a brake bufferdistance. In contrast, a physical model equation of the fall protection device having the axial buffer device according to the present invention is as follows: m*g* (L0+X) =1/2*k*X̂2+f_s*X, wherein k is elastic coefficient; f_s=μ_s*P*A; ·s is a friction coefficient of a contact surface; P is a surface pressure of an interference fit; A is a contacting area of a buffer ring (e.g. the first buffer ring) and a buffer rod. It would be understood from the two physical model equation mentioned above, the fall protection device having the axial buffer device of the present invention could have a shorter brake bufferdistance X due to being disposed with the spring (e.g. the first spring).

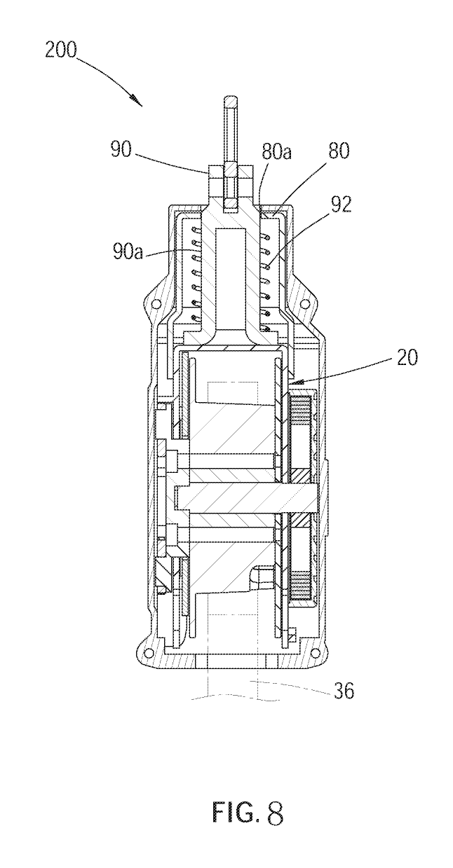

As illustrated in FIG. 8, a fall protection device 200 of another embodiment according to the present invention is different from the fall protection device 100 of the aforementioned embodiment in that: an axial buffer device of the fall protection device 200 further includes a buffer member 80 and a buffer rod 90. Wherein, the buffer member 80 is disposed on the frame 20, wherein a through hole is formed on the buffer member 80, and an inner surface of the through hole forms a second friction surface 80a. The buffer rod 90 is disposed between the frame 20 and the buffer member 80. One end of the buffer rod 90 penetrates through the through hole, and an outer peripheral surface of the buffer rod 90 forms a first friction surface 90a, which faces the second friction surface 80a. Whereby, the sliding of the buffer member 80 on the buffer rod 90 with friction also could be utilized to cushion the falling force of the safety belt and the worker so as to slow down the falling speed. In addition, a spring 92 also could be disposed in the axial buffer device to be connected to the buffer rod 90 so as to provide a suitable elastic force for the buffer rod. For example, in the current embodiment, the spring 92 is a compressed spring to be fit around the buffer rod 90, wherein one end of the spring 92 abuts against the buffer rod 90 and another end abuts against the buffer member 80, which provides a good buffering performance additionally. Furthermore, in one embodiment, the spring 92 could be other types of springs, such as a tension spring to be connected between the buffer rod 90 and the frame 20, and is not limited to the above example.

It is worth mentioning that a default value whether the pulling force applied to the safety belt is greater enough is used as a reference to determine whether a buffering effect of the axial buffer device is initiated or not. In practice, the default value could be different values according to a degree of the interference fit and a contacting area between the buffer rod and the buffer member, an elastic coefficient of the spring, or the arrangement of the fall protection device for different applications. For example, the default value is mainly determined by the friction between the buffer rod and the buffer member. However, when the axial buffer device further includes a spring, the default value would be further adjusted by an elastic force provided by the spring. In addition, in one embodiment, the brake unit or the rewinding unit could be omitted. For example, when the safety belt wound on the rotation member is being pulled out until the rotation member stops rotating, such as a full length or nearly a full length of the safety belt is pulled out, the force applies to the rotation member through the safety belt would be greater than a default value, and the buffer member of the axial buffer device would be pulled to slide on the buffer rod with friction, which could cushion the falling force.

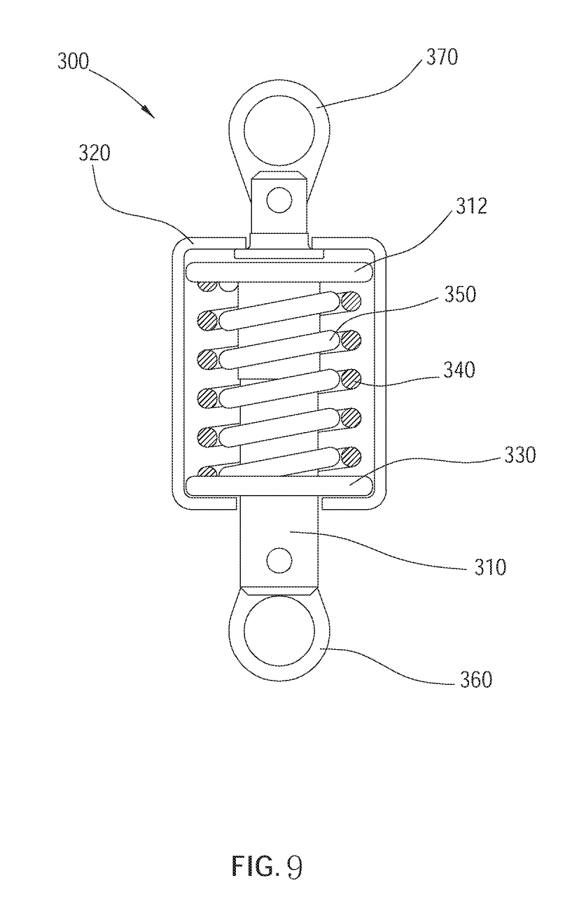

As illustrated in FIG. 9, an axial buffer device 300 of a second embodiment according to the present invention has almost the same structure with the axial buffer device 10 mentioned above, which includes a buffer rod 310, a buffer member including a holder 320 and a first buffer ring 330, and a first spring 340. Particularly, the axial buffer device 300 further includes a second spring 350. Wherein, the buffer rod 310 is disposed in the holder 320; the first buffer ring 330 is fit around the buffer rod 310 and disposed in the holder 320; the first spring 340 is fit around the buffer rod 310, wherein one of the two ends of the first spring 340 is adapted to be connected to the buffer rod 310, such as being connected to a flange 312 of the buffer rod 310, and the other of the two ends of the first spring 340 is adapted to be connected to the first buffer ring 330; the second spring 350 is fit around the buffer rod 310, and is interposed between the first spring 340 and the buffer rod 310, wherein one of the two ends of the second spring 350 is adapted to be connected to the buffer rod 310, such as being connected to a flange 312 of the buffer rod 310, and the other of the two ends of the second spring 350 is adapted to be connected to the first buffer ring 330. In practical application, the axial buffer device 300 could be connected to a hanging point via the buffer rod 310 or the holder 320, while the other one could be adapted to be connected to an object, wherein the object includes, but is not limited to, a hook, a hoist ring, a lifting hook, a cord, etc. For example, in the current embodiment, one end of the buffer rod 310 is connected to a hoist ring 360, and one end of the holder 320 is connected to another hoist ring 370, whereby the buffer 310 and the holder 320 could utilize the hoist rings 360, 370 to indirectly connect to the hanging point or the object respectively. In addition, by utilizing the parallel type spring buffer member having the first spring 340 and the second spring 350, the axial buffer device 300 could provide a good buffer performance For example, when the pull ring 360 on the buffer rod 310 is pulled by a force which is greater than a default value, the flange 312 of the buffer rod 310 would be moved toward the first buffer ring 330 to compress the first spring 340 and the second spring 350, and the first buffer ring whose one end abuts against the holder 320 and another end abuts against the first spring 340 and the second spring 350 with elasticity would slide on the buffer rod 310 with friction, whereby the sliding friction and the elastic force of the springs would cushion the pulling force. In addition, when the pull ring 370 on the holder 320 is pulled upward by a force which is greater than a default value as shown in FIG. 9, the holder 320 would abut against the first buffer ring 330 and push the first buffer ring 330 toward the flange 312 of the buffer rod 310, which makes the first buffer ring 330 to slide on the buffer rod 310 with friction and to compress the first spring 340 and the second spring 350, whereby the sliding friction and the elastic force of the springs could be utilized to cushion the pulling force. Furthermore, in other applications, it is not limited to be disposed with two springs. In one embodiment, the axial buffer device could include a combination of three or more springs.

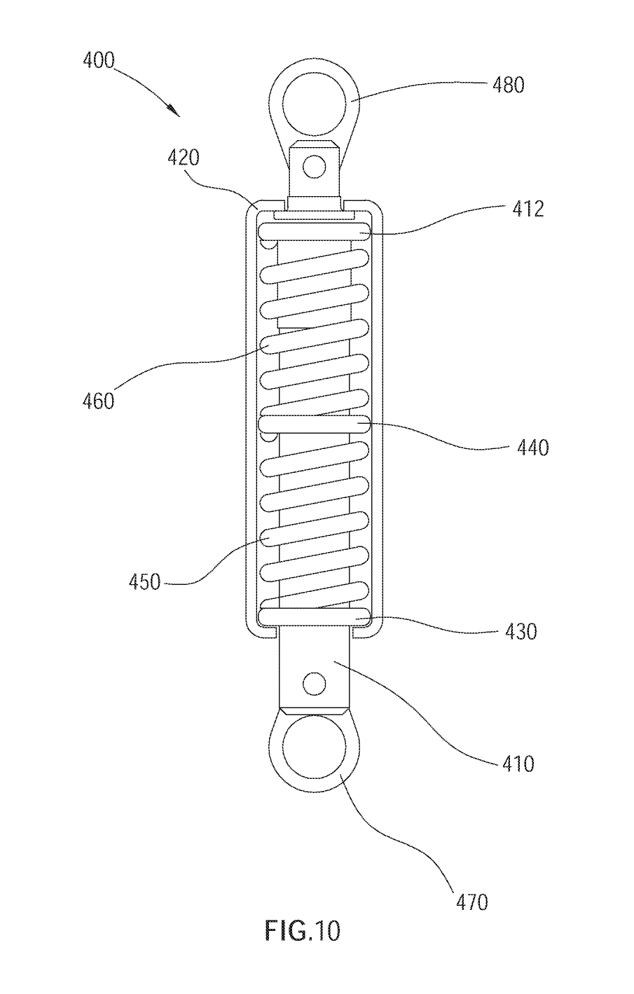

As illustrated in FIG. 10, an axial buffer device 400 of a third embodiment according to the present invention includes a buffer rod 410, a buffer member including a holder 420, a first buffer ring 430 and a second buffer ring 440, a first spring 450, and a second spring 460. The buffer rod 410 which includes a first friction surface is disposed in the holder 420. The first buffer ring 420 is fit around the buffer rod 410, wherein the first buffer ring 430 includes a second friction surface which faces and contacts the first friction surface, and preferably, a fitting relation between the first buffer ring 430 and the buffer rod 410 is an interference fit. The second buffer ring 440 is fit around the buffer rod 410, wherein the second buffer ring 440 includes a third friction surface which faces and contacts the first friction surface, and preferably, a fitting relation between the second buffer ring 440 and the buffer rod 410 is an interference fit. The first spring 450 is fit around the buffer rod 410 and is located between the first buffer ring 430 and the second buffer ring 440, wherein two ends of the first spring 450 are adapted to connect to the first buffer ring 430 and the second buffer ring 440 respectively. The second spring 460 is fit around the buffer rod 410, wherein two ends of the second spring 460 are connected to the buffer rod 420 and the second buffer ring 440 respectively, such as one end of the second spring 460 abuts against a flange 412 of the buffer rod 410 and another end of the second spring 460 abuts against the second buffer ring 440. In practical application, the axial buffer device 400 could be connected to a hanging point via the buffer rod 410 or the holder 420, while another one is adapted to connect to an object. In addition, in the current embodiment, a hoist ring 470 is connected to one end of the buffer rod 410, and another hoist ring 480 is connected to the holder 420, whereby the buffer rod 410 and the holder 420 could be indirectly connected to the hanging point or the object via the hoist rings 470, 480 respectively. By utilizing the double buffer rings and the serial type spring buffer member having the two springs, the axial buffer device 400 could provide a good buffer performance For example, when the hoist ring 480 on the holder 420 is connected to a hanging point and the hoist ring 470 on the buffer rod 410 is pulled by a force which is greater than a default value, the flange 412 of the buffer rod 410 would compress the second spring 460, and the second buffer ring 440 which is respectively pushed by elastic forces of the second spring 460 and the first spring 450 would slide on the buffer rod 410 with friction; meanwhile, the second buffer ring 440 would compress the first spring 450, which applies a force onto the first buffer ring 430 to make the first buffer ring 430 to slide on the buffer rod 410 with friction, whereby the sliding friction between each of the buffer rings and the buffer rod, and the elastic force of each of the springs could be utilized to cushion the pulling force. In addition, in other applications, it is not limited to be disposed with two springs and two buffer rings. In one embodiment, the axial buffer device could be disposed with three or more springs and buffer rings. However, it is not limited thereto.

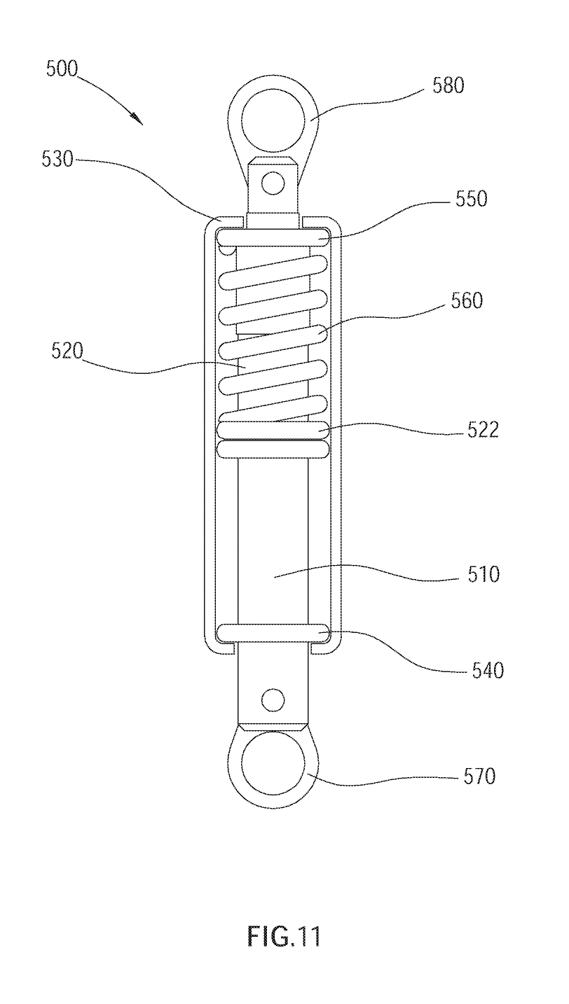

As illustrated in FIG. 11, an axial buffer device 500 of a fourth embodiment according to the present invention includes two buffer rods, a buffer member, and at least one spring. The two buffer rods are a first buffer rod 510 and a second buffer rod 520, wherein the first buffer rod includes a first friction surface, and the second buffer rod 520 includes a fourth friction surface. The buffer member includes a holder 530, a first buffer ring 540 and a second buffer ring 550, wherein the two buffer rods 530, 540, the first buffer ring 540 and the second buffer ring 550 are disposed within the holder 530. The first buffer ring 540 is fit around the first buffer rod 510, wherein the first buffer ring 540 includes a second friction surface which faces and contacts the first friction surface, and preferably, a fitting relation between the first buffer ring 540 and the first buffer rod is an interference fit. The second buffer ring 550 is fit around the second buffer rod 520, wherein the second buffer ring 550 includes a third friction surface which faces and contacts the fourth friction surface, and preferably, a fitting relation between the second buffer ring 550 and the second buffer rod 520 is an interference fit. In addition, the axial buffer device 500 could further include at least one spring 560 which is fit around one of the two buffer rods. For example, in the current embodiment, the spring 560 is fit around the second buffer rod 520, wherein two ends of the spring 560 are adapted to connect to the second buffer ring 550 and the second buffer rod 520 respectively, such as one end of the spring 560 abuts against the second buffer ring 550, and another end abuts against a flange 522 of the second buffer rod 520. In practical application, the first buffer rod 510 or the second buffer rod 520 is adapted to connect to a hanging point, and another one is adapted to connect to an object. Furthermore, in the current embodiment, a hoist ring 570 and another hoist ring 580 are connected to the first buffer rod 510 and the second buffer rod 520 respectively, whereby the first buffer rod 510 and the second buffer rod 520 could be indirectly connected to the hanging point or the object respectively. By utilizing the separate type spring buffer member having double buffer rods, it is favorable to provide a good buffer performance. Whereby, when the hoist ring 580 on the second buffer rod 520 is connected to a hanging point and the hoist ring 570 on the first buffer rod 510 is pulled by a force which is greater than a default value, the first buffer rod 510 would drive the first buffer 540 to apply a pressure to the holder 530, and then the holder 530 would apply a pressure onto the second buffer ring 550; meanwhile, when the second buffer slides on the second buffer rod 520 with friction, the spring 560 would be also compressed. Therefore, the sliding friction between each of the buffer rings and the second buffer rod 520, and the elastic force of the spring could be utilized to cushion the pulling force. In addition, in other applications, the spring 560 could be disposed on the first buffer rod 510 or each of the first buffer rod 510 and the second buffer rod 520 could be mounted with a spring respectively.

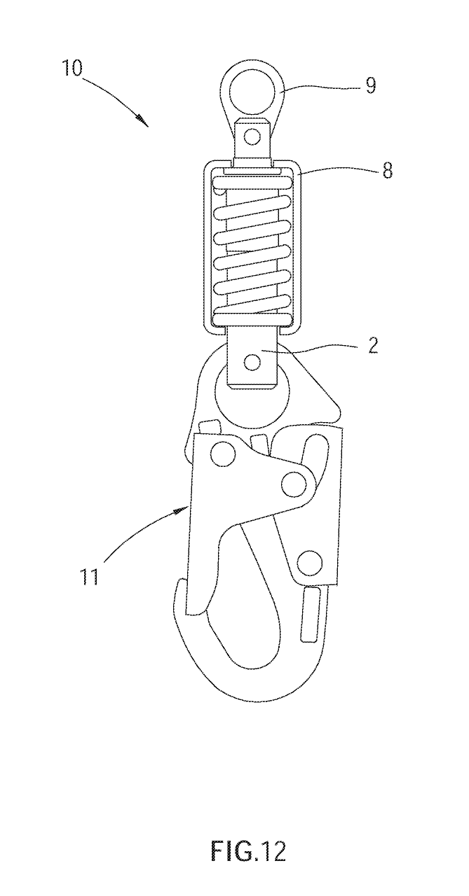

Referring to FIG. 12, it is a schematic view of an application of the axial buffer device of one embodiment according to the present invention with a hook. Wherein, the axial buffer device could be any one of the axial buffer devices of the first to the fourth embodiments as described above. In the current embodiment, the axial buffer device 10 of the first embodiment is utilized as an example. Particularly, a hoist ring 9 is connected to a top of the holder 8, which is adapted to connect to a hanging point, and the buffer rod 2 is adapted to connect to a hook 11. Whereby, the hook 11 could be adapted to hang an object, an apparatus or a worker; especially when the hook 11 is pulled by a force which is greater than a default value, the axial buffer device 10 could provide a brake buffer effect correspondingly.

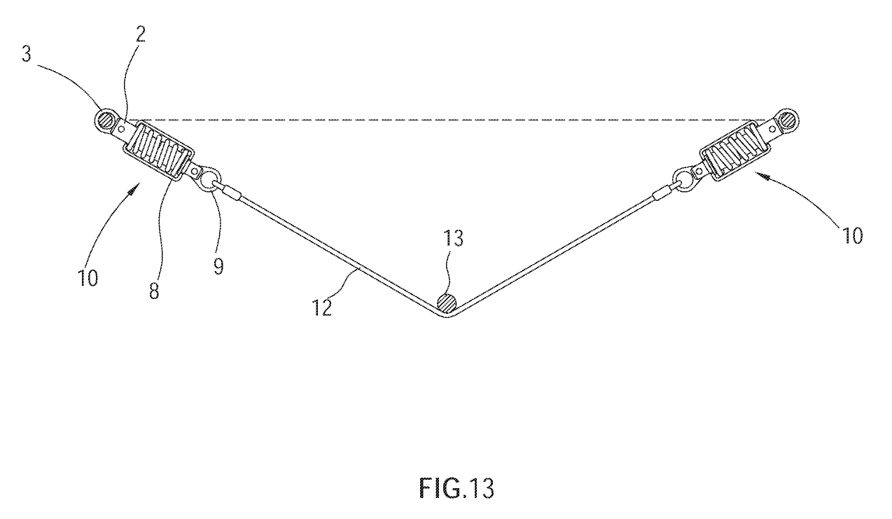

Referring to FIG. 13, it is a schematic view showing a cord is connected between two axial buffer devices of an embodiment according to the present invention. Wherein, the axial buffer device could be any one of the axial buffer devices of the first to the fourth embodiments. In the current embodiment, for example, the axial buffer device 10 of the first embodiment is utilized as the two buffer devices. Particularly, two hoist rings 3 are respectively connected to each of the buffer rods 2 of the two axial buffer devices 10, wherein each of the other ends of the two hoist rings 3 is connected to a hanging point. Two hoist rings 9 are respectively connected to each of the holders 8 of the two axial buffer device 10, wherein each of the other ends of the two hoist rings 9 is respectively connected to one of the two ends of the cord 12. An object 13 could be hung on the cord 12, wherein a weight of the object 13 would apply a pressure on the cord 12, which makes the cord 12 to pull the axial buffer device 10; when the force applied to any one of the two axial buffer devices is greater than a default value, the axial buffer device 10 would provide a corresponding brake buffer effect.

It shall be understood that two ends of each of the springs, the first spring or the second spring of each of the above embodiments are not necessary to abut against the flange of the buffer rod or the buffer member at an initial state but are spaced apart with a predetermined distance when the axial buffer device is not initiated or does not cushion. Until the buffer member slides on the buffer rod with friction, the two ends of the spring would be connected or abut against the buffer rod and the buffer member to provide an elastic force to the cushioning process.

It is worth mentioning that the aforementioned axial buffer device is not limited to the axial buffer device of the first embodiment, and could be any one of the axial buffer devices of the second to the fourth embodiments.

It must be pointed out that the embodiments described above are only some embodiments of the present invention. The fall protection device is not only adapted to attach to a worker to provide a protection when the worker accidentally falls, but also could be adapted to hang on an object such as working material or a machine tool, which could also avoid a rapid falling of the working material or the machine tool. All equivalent structures which employ the concepts disclosed in this specification and the appended claims should fall within the scope of the present invention.

What is claimed is:

1. An axial buffer device, comprising:
a buffer rod, including a first friction surface; and
a buffer member, including a second friction surface which contacts the first friction surface; when any one of the buffer rod and the buffer member is pulled by a force which is greater than a default value to overcome a maximum friction between the buffer member and the buffer rod, the buffer member would slide on the buffer rod with friction.

2. The axial buffer device of claim 1, further comprising a first spring, wherein the first spring is connected to the buffer rod to provide an elastic force to the buffer rod.

3. The axial buffer device of claim 2, wherein the first spring is fit around the buffer rod; one of two ends of the first spring is adapted to connect to the buffer rod, and another one of the two ends of the first spring is adapted to connect to the buffer member.

4. The axial buffer device of claim 3, further comprising a second spring, wherein the second spring is fit around the buffer rod and interposed between the first spring and the buffer rod; one of two ends of the second spring is adapted to connect to the buffer rod, and another one of the two ends of the second spring is adapted to connect to the buffer member.

5. The axial buffer device of claim 1, wherein an outer peripheral surface of the buffer rod forms the first friction surface; a through hole is disposed on the buffer member and includes an inner peripheral surface which forms the second friction surface; a fitting relation between the second friction surface and the first friction surface is an interference fit.

6. The axial buffer device of claim 1, wherein the buffer member comprises a holder and a first buffer ring; the first buffer ring and the buffer rod are disposed within the holder; the first buffer ring is fit around the buffer rod and includes the second friction surface.

7. The axial buffer device of claim 6, further comprising a first spring, wherein the first spring is fit around the buffer rod; one of two ends of the first spring is adapted to connect to the buffer rod, and another one of the two ends is adapted to connect to the first buffer ring.

8. The axial buffer device of claim 7, further comprising a second spring, wherein the second spring is fit around the buffer rod and interposed between the first spring and the buffer rod; one of two ends of the second spring is adapted to connect to the buffer rod, and another one of the two ends of the second spring is adapted to connect to the first buffer ring.

9. The axial buffer device of claim 6, wherein the buffer member further comprises a second buffer ring; the second buffer ring is fit around the buffer rod and includes a third friction surface which faces the first friction surface of the buffer rod; the axial buffer device further comprises a first spring and a second spring; the first spring is fit around the buffer rod and disposed between the first buffer ring and the second buffer ring; two ends of the first spring respectively connect to the first buffer ring and the second buffer ring; the second spring is fit around the buffer rod; two ends of the second spring respectively connect to the second buffer ring and the buffer rod.

10. The axial buffer device of claim 1, further comprising another buffer rod, wherein the two buffer rods are disposed coaxially; the buffer member includes a holder, a first buffer ring and a second buffer ring; the two buffer rods, the first buffer ring and the second buffer ring are disposed within the holder; the first buffer is fit around the buffer rod and includes the second friction surface; the second buffer ring is fit around the other buffer rod and includes a third friction surface which contacts a fourth friction surface on the other buffer rod.

11. The axial buffer device of claim 10, further comprising at least one spring, wherein the at least one spring is fit around one of the two buffer rods.

12. A fall protection device including an axial buffer device as in claim 1 and adapted to connect to a safety belt, further comprising:
a frame; and
a rotation member disposed in the frame and adapted to roll up the safety belt; wherein one of the buffer rod and the buffer member is adapted to connect to a hanging point, and the another one is adapted to connect to the frame.

13. The fall protection device of claim 12, further comprising a brake unit and a housing, wherein
the brake unit is disposed on the rotation member to restrict a rotation of the rotation member;
the housing includes a first half housing and a second half housing which are opposite and joined to each other; a first division plate is disposed in the first half housing and a second division plate is disposed in the second half housing which is opposite to the first division plate;
the rotation member is disposed in one part of the housing which is at one side of the first division plate and the second division plate, and the brake unit is disposed in another part of the housing which is at another side of the first division plate and the second division plate.

14. The fall protection device of claim 13, wherein the rotation member includes a shaft lever and a rotary drum; the brake unit is mounted on the shaft lever; the rotary drum is fit around the shaft lever to be rotated with the shaft lever coaxially.

15. The fall protection device of claim 14, wherein a fitting relation between the rotary drum and the shaft lever is an interference fit.
